(19) United States
(12) Patent Application Publication
(10) Pub. No.: US 2026/0227976 A1
(43) Pub. Date: Aug. 6, 2026

(54) COMPILATION CONTROL APPARATUS AND COMPILATION CONTROL METHOD

(71) Applicant: Toshiba Tec Kabushiki Kaisha, Tokyo (JP)

(72) Inventor: Yasuhiro INAGAKI, Mishima Shizuoka (JP)

(21) Appl. No.: 19/427,227

(22) Filed: Dec. 19, 2025

(30) Foreign Application Priority Data
Feb. 3, 2025 (JP) 2025-016316

(51) Int. Cl. G06F 8/41; G06F 9/38

(52) U.S. Cl. CPC G06F 8/41; G06F 9/3897

(57) ABSTRACT

According to an embodiment, a compilation control apparatus creates, when a kernel driver is compiled with reference to a kernel source, a path identical to an absolute path specified in advance on a container used for the compilation. Additionally, the compilation control apparatus mounts the specified absolute path on the path created on the container.

### CROSS-REFERENCE TO RELATED APPLICATIONS

This application is based upon and claims the benefit of priority from the prior Japanese Patent Application No. 2025-016316, filed on February 3, 2025, the entire contents of which are incorporated herein by reference.

### FIELD

An embodiment described herein generally relates to a compilation control apparatus and a compilation control method.

### BACKGROUND

An approach to mount a kernel driver on a container is known as a method for compiling a kernel driver using the container technology.

It should be noted that this approach needs a kernel source and path information of the kernel source in order to compile the kernel driver. Therefore, if a unique kernel source is used, compilation can be performed. However, if a kernel path to be used is defined in advance in a host system, the kernel driver cannot be compiled without duplicating the kernel source, for example.

### BRIEF DESCRIPTION OF THE DRAWINGS

FIG. 1 is a block diagram showing an example of a hardware configuration of a compilation control apparatus according to an embodiment.

FIG. 2 is a block diagram showing an example of a functional configuration of the compilation control apparatus according to the embodiment.

FIG. 3 is a flowchart showing an example of compilation processing in the compilation control apparatus according to the embodiment.

FIG. 4 is a diagram showing an example of a symbolic link of a kernel source according to the embodiment.

FIG. 5 is a diagram showing an example of a kernel driver compiling command when a relative path is specified, which is not according to the embodiment.

FIG. 6 is a diagram showing an example of a kernel driver compiling command that is input to the compilation control apparatus according to the embodiment.

### DETAILED DESCRIPTION

According to an embodiment, a compilation control apparatus includes a storage and a control circuit. The storage stores a kernel source and a kernel driver. The control circuit creates, when the kernel driver is compiled with reference to the kernel source, a path identical to an absolute path specified in advance on a container used for the compilation. Further, the control circuit mounts the specified absolute path on the path created on the container.

Hereinafter, the compilation control apparatus according to the embodiment will be described with reference to the drawings. In the drawings, the same reference symbols denote the same or similar portions. The compilation control apparatus according to the embodiment is an information processing apparatus having a function to compile a Linux (registered trademark) kernel driver in a Linux development environment. In the following, Linux will be referred to as "host OS" or "host". A Linux kernel source code is an example of a kernel source, and a Linux kernel driver is an example of a kernel driver.

### 1. Configuration

First, a configuration of the compilation control apparatus according to the embodiment will be described.

### 1. 1 Hardware Configuration

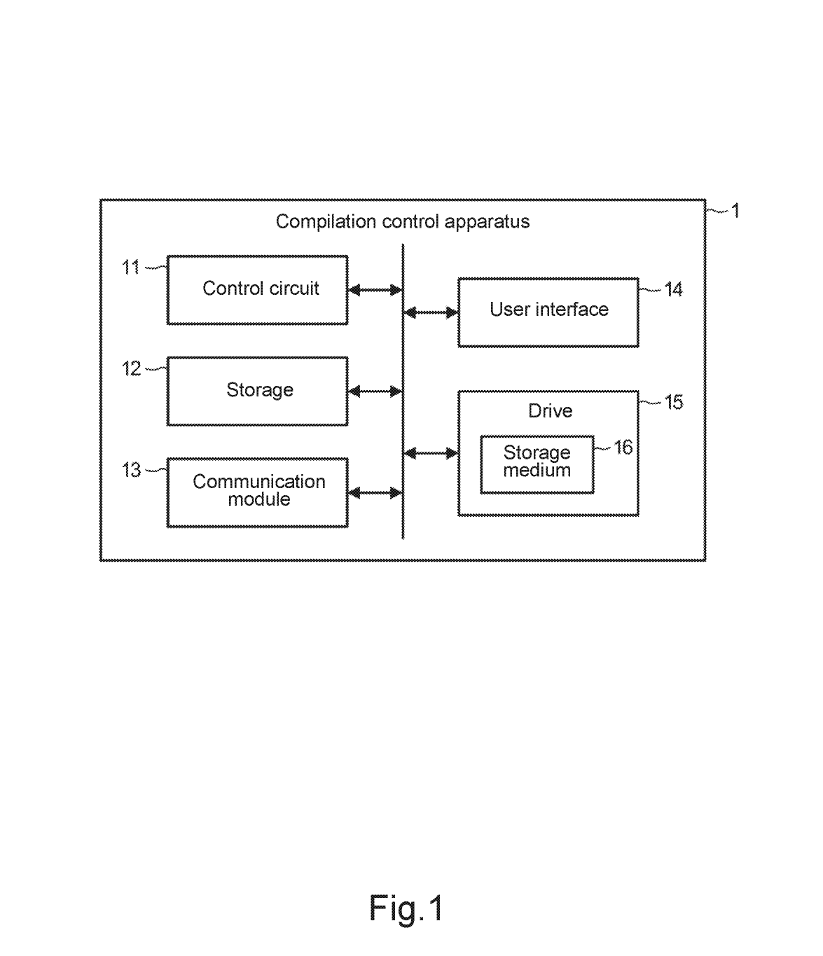

FIG. 1 is a diagram showing an example of a hardware configuration of the compilation control apparatus according to the embodiment.

As shown in FIG. 1, a compilation control apparatus 1 includes a control circuit 11, a storage 12, a communication module 13, a user interface 14, and a drive 15.

The control circuit 11 is a circuit that controls the components of the compilation control apparatus 1 as a whole. The control circuit 11 includes a central processing unit (CPU), a random access memory (RAM), a read only memory (ROM), and the like. The ROM of the control circuit 11 stores programs or the like used for various types of processing by the compilation control apparatus 1. The CPU of the control circuit 11 controls the entire compilation control apparatus 1 according to the programs stored in the ROM of the control circuit 11. The RAM of the control circuit 11 has a work area for the CPU of the control circuit 11.

The storage 12 includes, for example, a hard disk drive (HDD) or a solid state drive (SSD). The storage 12 stores information that is used for various types of processing performed in the compilation control apparatus 1.

The communication module 13 is a circuit that is used to transmit and receive data between the compilation control apparatus 1 and a network (not shown).

The user interface 14 is a device that controls communication between the compilation control apparatus 1 and a user. The user interface 14 includes an input device and an output device. The input device includes, for example, a touch panel, a keyboard, and operation buttons. The output device includes, for example, a printer, a speaker, and a display.

The drive 15 is a device for reading software stored on a storage medium 16. The drive 15 includes, for example, a compact disk (CD) drive or a digital versatile disk (DVD) drive.

The storage medium 16 is a medium that stores software by electrical, magnetic, optical, mechanical, or chemical action. The storage medium 16 may store programs for executing various types of processing in the compilation control apparatus 1.

### 1. 2 Functional Configuration

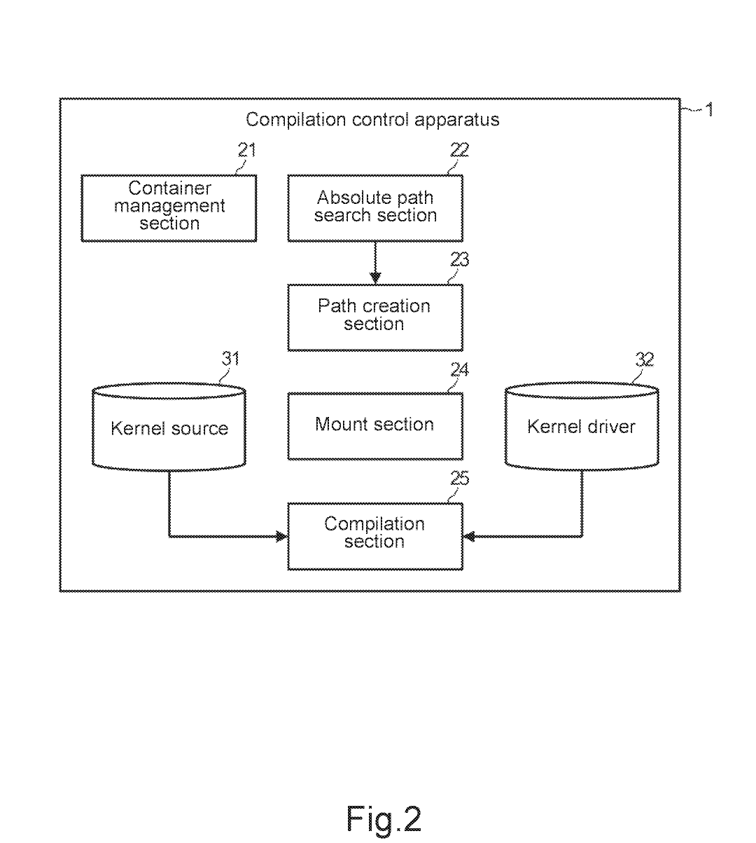

FIG. 2 is a block diagram showing an example of a functional configuration of the compilation control apparatus 1 according to the embodiment.

As shown in FIG. 2, the CPU of the control circuit 11 loads programs stored in the ROM of the control circuit 11 or the storage medium 16 into the RAM of the control circuit 11. The CPU of the control circuit 11 then interprets and executes the programs loaded into the RAM of the control circuit 11. The programs include a compilation control program according to the embodiment. The CPU of the control circuit 11 interprets and executes the compilation control program, so that the compilation control apparatus 1 functions as a computer including a container management section 21, an absolute path search section 22, a path creation section 23, a mount section 24, and a compilation section 25. Additionally, the storage 12 of the compilation control apparatus 1 stores a kernel source 31 and a kernel driver 32.

The container management section 21 functions as a platform that provides a containerized virtual environment. The container management section 21 manages the startup and termination of a container in response to the execution of a compilation command. Additionally, the container management section 21 manages a directory structure on the container. The container management section 21 is, for example, a Docker engine. The container is, for example, a Docker container.

The absolute path search section 22 searches for an absolute path of the kernel source 31 on the host system. The path creation section 23 creates the path searched for by the absolute path search section 22 on the container. The mount section 24 mounts the path searched for by the absolute path search section 22 on the path created by the path creation section 23, and also mounts a path of the kernel driver 32 to be compiled.

The compilation section 25 performs compilation of the kernel driver 32 on the basis of the paths mounted on the container.

### 2. Operation

Next, an operation in the compilation control apparatus 1 according to the embodiment will be described.

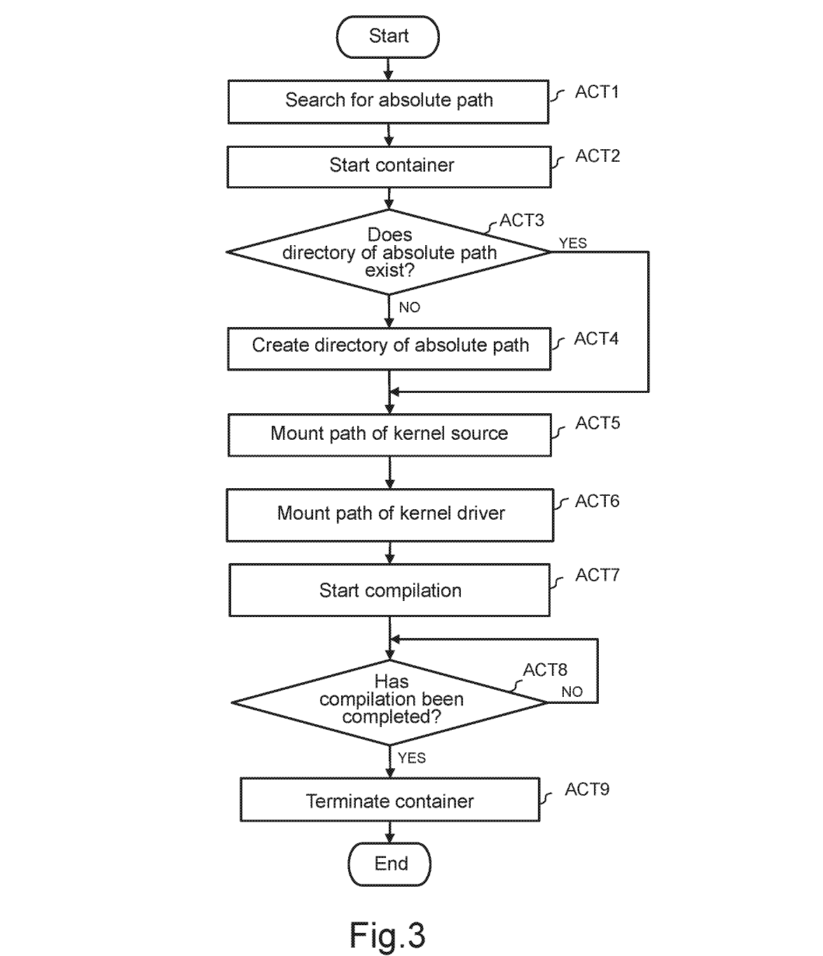

FIG. 3 is a flowchart showing an example of compilation processing in the compilation control apparatus 1 according to the embodiment. When the user inputs (starts) a compilation command, the procedure of this flowchart is started.

First, the absolute path search section 22 searches for an absolute path of the kernel source 31 on the host system (ACT1). The absolute path is a description starting from the top directory in the directory structure on the host system and ending at the kernel source 31. For example, the host system holds the absolute path of the kernel source 31 as a symbolic link or the like in a prescribed directory. Therefore, the absolute path search section 22 can search for the absolute path of the kernel source 31 from this symbolic link.

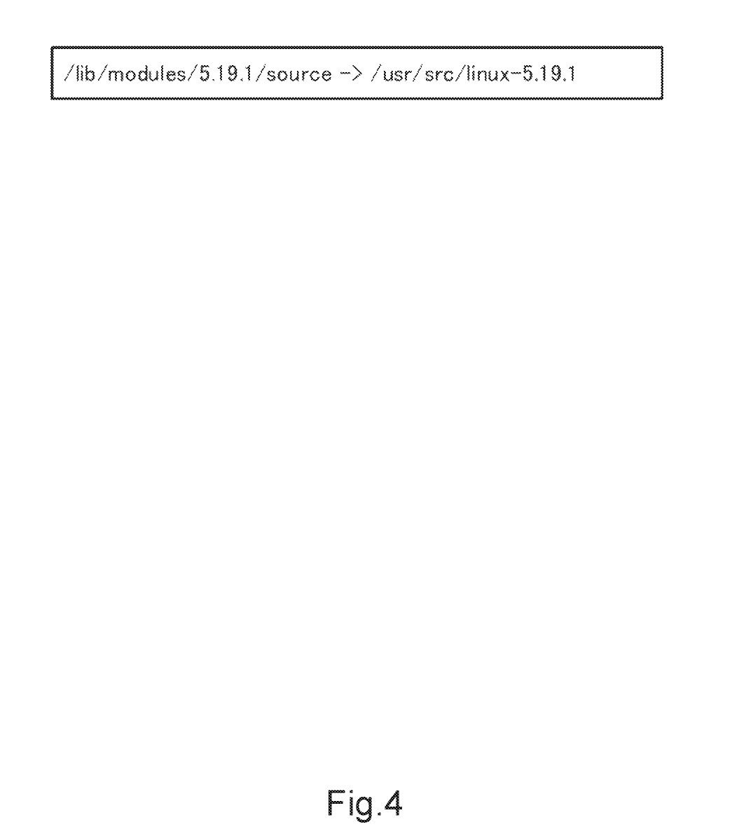

FIG. 4 is a diagram showing an example of the symbolic link of the kernel source. In FIG. 4, the prescribed directory is indicated by the path of "/lib/modules/5.19.1/source", and in this case, "5.19.1" is a kernel version. The absolute path of the kernel source 31 is "/usr/src/linux-5.19.1". This absolute path indicates that the kernel source 31 with the file name of "linux-5.19.1" is stored in the directory of "/usr/src/".

Next, the container management section 21 starts the container (ACT2).

The absolute path search section 22 then determines whether or not the directory of the absolute path searched for in ACT1, for example, "/usr/src/", exists on the container started in ACT2 (ACT3).

In this case, if the directory of the absolute path searched for does not exist on the container (ACT3: NO), the path creation section 23 creates the absolute path searched for in ACT1 on the container (ACT4).

Note that if the directory of the absolute path searched for exists on the container (ACT3: YES), this ACT4 is skipped.

Next, the mount section 24 mounts the absolute path searched for in ACT1 on the directory of the absolute path searched for if the directory of the absolute path searched for exists on the container, or on the directory created in ACT3 if the directory of the absolute path searched for does not exist on the container (ACT5). In other words, the mount section 24 mounts the absolute path of the kernel source 31 on the host system, on the directory of the absolute path on the container.

Further, the mount section 24 mounts the path of the kernel driver 32 to be compiled also on the directory of the absolute path on the container (ACT6).

The compilation section 25 then starts compilation of the kernel driver 32 on the basis of the paths mounted on the container, with a specified kernel driver compiling command (ACT7).

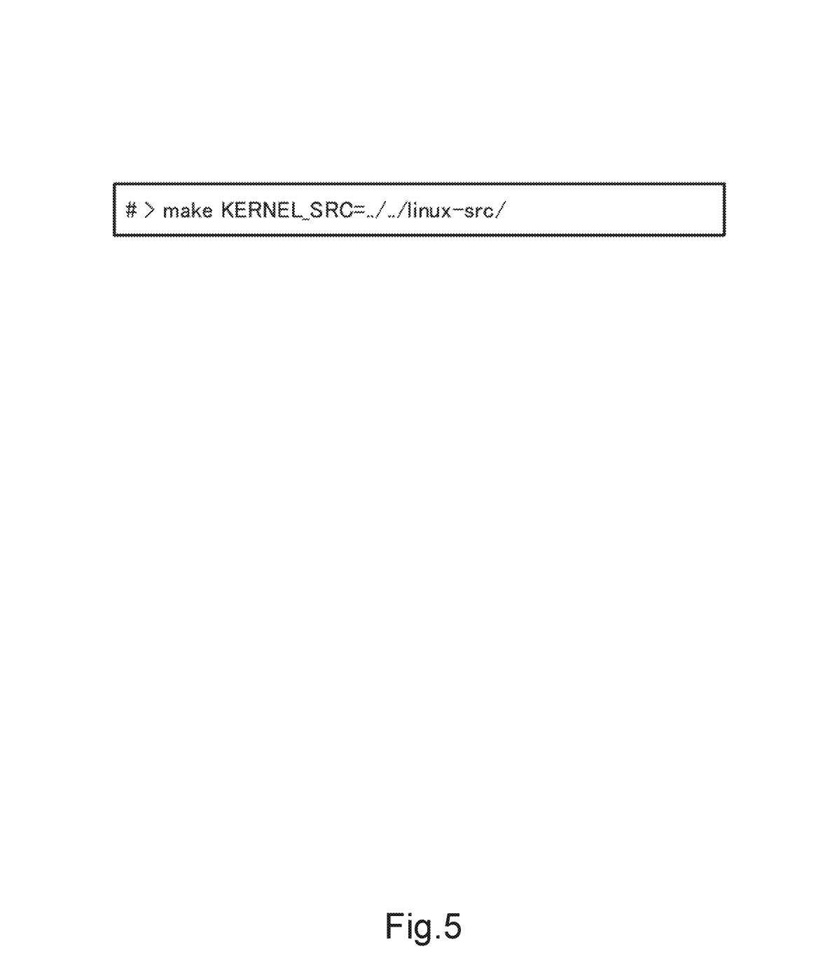

FIG. 5 is a diagram showing an example of a kernel driver compiling command when a conventional relative path is specified, which is not according to the embodiment. When the kernel driver 32 is compiled using the kernel source 31 used in the host system, it is necessary to perform an operation such as duplicating the kernel source 31 in a directory with a relative path specified in advance. FIG. 5 shows an example of a case where the kernel source 31 is duplicated in the "linux-src" directory, which is a directory two levels higher than the directory of the kernel driver 32 as the starting point.

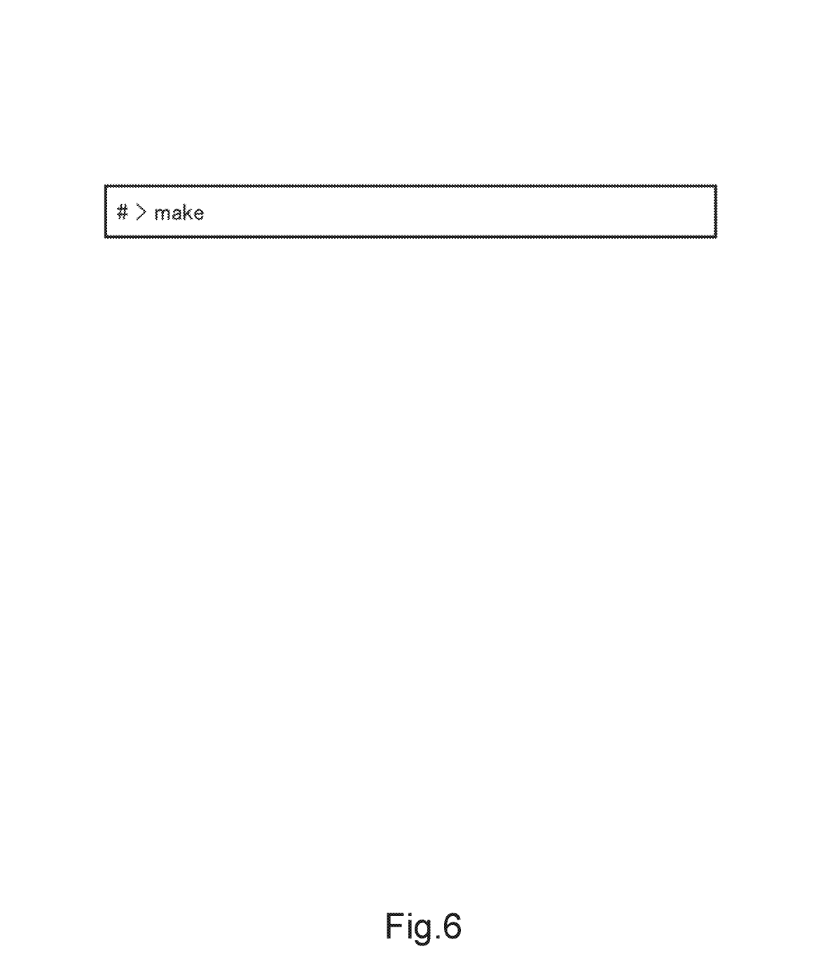

FIG. 6 is a diagram showing an example of a kernel driver compiling command that is input to the compilation control apparatus 1 according to the embodiment. As shown in FIG. 6, the kernel driver compiling command in this case can be a make command that is a command to compile the kernel driver 32 in the host system without using a container.

If the execution of compilation of the kernel driver 32 has started in ACT7, the container management section 21 determines whether or not the execution of compilation by the compilation section 25 has been completed (ACT8). If the execution of the compilation has not yet been completed (ACT8: NO), the container management section 21 waits for a certain period of time, for example, and determines again whether or not the execution of the compilation has been completed.

If the execution of the compilation by the compilation section 25 has been completed (ACT8: YES), the container management section 21 terminates the container (ACT9).

### 3. Advantageous Effects According to Embodiment

As described above, in the compilation control apparatus 1 according to one embodiment, when the kernel driver 32 is compiled with reference to the kernel source 31, the path creation section 23 creates a path identical to the absolute path specified in advance on the container used for compilation, and the mount section 24 mounts the specified absolute path on the path created on the container. This allows the compilation control apparatus 1 according to one embodiment to compile the kernel driver 32 in a container without the need to perform duplication of the kernel source 31, even if it is used in the host system and a kernel path is defined in advance. This makes it easy to build the kernel driver 32. Additionally, the kernel driver compiling command can be the same as the command to compile the kernel driver 32 in the host system without using a container. This eliminates the need to change the command depending on whether complication is performed in a container or performed in the host system, making it easier for the host system to manage the commands and for the user to learn the commands.

Further, the compilation control apparatus 1 according to one embodiment includes the absolute path search section 22 that searches for a path of the kernel source 31 on the host system as a specified absolute path. As a result, in the compilation control apparatus 1 according to one embodiment, the absolute path specified in advance can be easily obtained.

Furthermore, here, in the compilation control apparatus 1 according to one embodiment, if the directory of the absolute path does not exist on the container, the path creation section 23 creates, on the container, a path identical to the absolute path searched for by the absolute path search section 22. Thus, in the compilation control apparatus 1 according to one embodiment, if there is no need to create a path on the container, the operation of the path creation section 23 does not need to be performed, which leads to a faster operation.

### 4. Other Embodiments

Hereinabove, one embodiment of the compilation control apparatus, the compilation control method, and the compilation control program has been described, but such embodiment is not limited thereto.

For example, the aforementioned flow of the information processing performed by the CPU of the control circuit 11, described with reference to the flowchart, is an example and is not limited to this sequence. For example, the absolute path searching process in ACT1 and the container starting process in ACT2 may be reversed in the order of execution or may be performed in parallel. In such a manner, as long as there is no conflict with the preceding or subsequent processes, the processing order may be changed, or multiple processes may be performed in parallel.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A compilation control apparatus, comprising:
a storage configured to store a kernel source and a kernel driver; and
a control circuit configured to
create, when the kernel driver is compiled with reference to the kernel source, a path identical to an absolute path specified in advance on a container used for the compilation, and
mount the specified absolute path on the path created on the container.

2. The compilation control apparatus according to claim 1, wherein
the control circuit compiles the kernel driver on a basis of the path mounted on the container.

3. The compilation control apparatus according to claim 1, wherein
the control circuit searches for a path of the kernel source on the host system as the specified absolute path.

4. The compilation control apparatus according to claim 3, further comprising
a user interface, wherein
the control circuit searches for an absolute path of the kernel source on the host system when a compilation command is input via the user interface.

5. The compilation control apparatus according to claim 4, wherein
the absolute path is a description starting from a top directory in a directory structure on the host system and ending at the kernel source,
the host system holds the absolute path of the kernel source as a symbolic link or the like in a prescribed directory, and
the control circuit searches for the absolute path of the kernel source from the symbolic link.

6. The compilation control apparatus according to claim 3, wherein
the control circuit determines whether or not a directory of the absolute path searched for exists on the container.

7. The compilation control apparatus according to claim 6, wherein
the control circuit creates, if the directory of the absolute path does not exist on the container, a directory of a path identical to the absolute path searched for on the container.

8. The compilation control apparatus according to claim 7, wherein
the control circuit mounts the absolute path searched for on the crated directory.

9. The compilation control apparatus according to claim 6, wherein
the control circuit mounts, if the directory of the absolute path exists on the container, the absolute path searched for on the directory of the absolute path that exists on the container.

10. A compilation control method for a compilation control apparatus, the compilation control method comprising:
storing a kernel source and a kernel driver;
creating, when the kernel driver is compiled with reference to the kernel source, a path identical to an absolute path specified in advance on a container used for the compilation; and
mounting the specified absolute path on the path created on the container.
